(19) United States
(12) Patent Application Publication
(10) Pub. No.: US 2014/0279375 A1
(43) Pub. Date: Sep. 18, 2014

(54) METHOD AND DEVICE FOR PROCESSING PRICE AND METHOD AND ELECTRONIC COMMERCE SYSTEM FOR PROCESSING ORDER SHEET

(71) Applicant: TENCENT TECHNOLOGY (SHENZHEN) COMPANY LIMITED, Shenzhen (CN)

(72) Inventors: Jinxiong YANG, Shenzhen (CN); Jun Xie, Shenzhen (CN); YanYan Li, Shenzhen (CN); Yaohua Tan, Shenzhen (CN); Weihong Mo, Shenzhen (CN); Zhenming Chen, Shenzhen (CN); Tao Hu, Shenzhen (CN); Lie Guo, Shenzhen (CN)

(73) Assignee: TENCENT TECHNOLOGY (SHENZHEN) COMPANY LIMITED, Shenzhen (CN)

(21) Appl. No.: 14/290,131

(22) Filed: May 29, 2014

Related U.S. Application Data
(63) Continuation of application No. PCT/CN2014/070471, filed on Jan. 10, 2014.

(30) Foreign Application Priority Data
Feb. 5, 2013 (CN) 201310045893.7

(51) Int. Cl. G06Q 40/04

(52) U.S. Cl. CPC G06Q 40/04
USPC 705/37

(57) ABSTRACT

Described are a method and a device for processing price, a method and an electronic commerce system for processing order sheet. The method for processing price includes: obtaining attribute information of a commodity in an electronic commerce system; distributing a charging mark to the commodity according to the attribute information of the commodity; and setting price information corresponding to the charging mark of the commodity according to a predetermined price processing rule. The information price of the commodity is pertinently customized according to the attribute information of the electronic commerce system. The commodity of the electronic commerce system is strong pertinence that price may be adjusted flexibly and efficiently, and an intelligence of the electronic commerce system is improved.

### CROSS-REFERENCE TO RELATED APPLICATIONS

This is a U.S. continuation application under 35 U.S.C. §111(a) claiming priority under 35 U.S.C. §§120 and 365(c) to International Application No. PCT/CN2014/070471 filed on Jan. 10, 2014, which claims the priority benefit of Chinese Patent Application No. 201310045893.7 filed on Feb. 5, 2013, the contents of which are incorporated by reference herein in their entirety for all intended purposes.

### FIELD OF THE TECHNICAL

The present disclosure relates to a field of network information technology, and specifically to a method and a device for processing price, method and an electronic commerce system for processing an order sheet.

### BACKGROUND

With a development of internet technology, electronic commerce system is developed rapidly. Various electronic commerce systems appear to meet a demand of shopping online by the user. Various commodities are sold on the electronic commerce system. The commodities include not only tangible commodities (such as clothes, makeup) but also virtual commodities (such as, telephone fare, game coins).

Typically, in the electronic commerce system, take recharging for telephone online for example, as for a recharging card which face value is 100, there are various channels. That is, different internet entries for buying commodity may be selected by the customer. However, in the electronic commerce system, the price of the commodity is set by the supplier, and the price of the commodity may not be processed. In the example described above, the price information of the recharging card which face value is 100 is set by the recharging card suppliers of various channels. In the electronic commerce system, the price information of the recharging card having a same face value from various channels. Therefore, the commodity of the electronic commerce system is lack of pertinence. The price may not be adjusted pertinently according to different attribute information of the commodity. Therefore, the prices of the commodity may not be adjusted and managed effectively in the electronic commerce system.

### SUMMARY

A method and a device for processing price, a method and an electronic commerce system for processing order sheet are provide in an exemplary of present disclosure. The price information of the commodity may be pertinently customized according to attribute information of the commodity in the electronic commerce system. Thus, the commodity of the electronic commerce system is pertinence, the price of the commodity may be adjusted and managed flexibly and effectively, and an intelligence of the electronic commerce system is improved.

A method for processing price provided of an embodiment of present disclosure includes:

obtaining attribute information of a commodity in an electronic commerce system;

distributing a charging mark to the commodity according to the attribute information of the commodity;

setting price information corresponding to the charging mark of the commodity according to a predetermined price processing rule.

A device for processing price provided of an embodiment of present disclosure includes:

an information obtaining module obtaining attribute information of a commodity in an electronic commerce system;

a charging mark distributing module distributing a charging mark to the commodity according to the attribute information of the commodity;

a price processing module setting price information to the charging mark of the commodity according to a predetermined price processing rule.

An electronic commerce system of a third embodiment of present disclosure includes the device for processing price provided in the second embodiment.

A method for processing an order sheet of an embodiment of present disclosure includes:

obtaining an attribute information of a commodity when an order sheet operation to the commodity in an electronic commerce system is detected by a client;

transmitting an order sheet request with the attribute information of the commodity to the server by the client;

searching a charging mark to the commodity in a price database according to the attribute information of the commodity requested by the server;

defining price information corresponding to the charging mark according to the charging mark of the commodity searched by the server and feeding back the price information to the client by the server;

displaying the price information by the client on an order sheet of the commodity;

an establishment of establishing the price database by the server comprising:

obtaining the attribute information of the commodity in the electronic commerce system;

distributing the charging mark according to the attribute information of the commodity; and

setting the price information to the charging mark of the commodity according to a predetermined price processing rule.

An electronic commerce system of an embodiment of present disclosure includes a server and a client.

The server is configured for receiving an order sheet request transmitted by the client, searching for a charging mark of a commodity in a price database according to attribute information of the commodity carried in the order sheet request, defining price information corresponding to the charging mark according to the charging mark of the commodity, feeding back the price information to the client.

The client is configured for obtaining attribute information of the commodity when an order sheet operation to the commodity in the electronic commerce system is detected, transmitting an order sheet request to the server; the order sheet request carrying with the attribute information; receiving the price information of the commodity feed back by the server, and displaying the price information on order sheet of the commodity

An establishment of establishing the price database by the server includes:

obtaining the attribute information of the commodity in the electronic commerce system;

distributing the charging mark according to the attribute information of the commodity; and

setting the price information to the charging mark of the commodity according to a predetermined price processing rule.

In the embodiments of present disclosure, a charging mark is distributed to the commodity according to the attribute information of the commodity of the electronic commerce system. Price information corresponding to the charging mark is set according to the predetermined price processing rule. The information price of the commodity is pertinently customized according to the attribute information of the electronic commerce system. And the order sheet process is realized based on the price information customized. The commodity of the electronic commerce system is strong pertinence that the price may be adjusted flexibly and efficiently, and the intelligence of the electronic commerce system is improved.

### BRIEF DESCRIPTION OF THE DRAWINGS

In order to make the embodiment of present disclosure or the embodiment of prior art more clearly, the drawings which are needed in the embodiment of present disclosure or the embodiment of prior art are described simply as follows. It is obviously, the drawings described as the follows are only exemplary embodiments of present disclosure. To a person of ordinary skill in the art, under premise of no creative work, other drawings may be obtained according to the drawings.

FIG. 1 is a flow chart of a method for processing price according to an embodiment of present disclosure.

FIG. 2 is a flow chart of a method for processing price according to another embodiment of present disclosure.

FIG. 3 is a flow chart of a method for processing price according to yet another embodiment of present disclosure.

FIG. 4 is a schematic diagram of a device for processing price according to an embodiment of present disclosure.

FIG. 5 is a schematic diagram of a device for processing price according to another embodiment of present disclosure.

FIG. 6 is a schematic diagram of an order sheet processing module according to an embodiment of present disclosure.

FIG. 7 is a schematic diagram of an electronic commerce system according to an embodiment of present disclosure.

FIG. 8 is flow chart of a method for processing an order sheet according to an embodiment of present disclosure.

FIG. 9 is a schematic diagram of an electronic commerce system according to another embodiment of present disclosure.

### DETAILED DESCRIPTION OF ILLUSTRATED EMBODIMENTS

Further description of present disclosure will be illustrated clearly and completely, which combined with embodiments in drawings and detailed embodiments. Obviously, the embodiments here are not all embodiments but only part of embodiments of present disclosure. Based on the embodiments of present disclosure, under premise of without paying out creative work, other embodiments obtained by the person having ordinary skill in the art are considered to encompass within the scope of the present invention.

In the embodiment of present disclosure, the electronic commerce system includes at least one commodity. The commodity may be tangible commodity, such as, clothes, trousers, blanket, washing power, etc. The commodity may be virtual commodity, such as, telephone fare, lottery, game coin, etc. Each commodity of the electronic commerce system includes attribute information. The attribute information may be formed by one kind of information. The attribute information of the commodity may be marketing channel of the commodity, promotion information of the commodity, consumer information of the commodity, seller information of the commodity, supplier information of the commodity, or manufacture information of the commodity. The attribute information may be formed by several kinds of information. The attribute information may include a combination of the marketing channel of the commodity and the promotion information of the commodity. Or, the attribute information may also include a combination of the marketing channel of the commodity, the consumer information of the commodity, and the promotion information of the commodity, etc. In the following embodiment of present disclosure, the commodity may be any commodity in the electronic commerce system except for special insulate.

Further description of the method for processing price according to the embodiment of present disclosure will be illustrated, with a combination of FIG. 1 to FIG. 3.

Referring to FIG. 1, FIG. 1 is a flow chart of a method for processing price according to an embodiment of present disclosure. The method includes the step S101 to the step S103 as the follows.

Step S101, obtaining attribute information of a commodity in an electronic commerce system.

In the step, the attribute information of any commodity of the electronic commerce system may be obtained. The attribute information of the commodity is the factor influencing the price of the commodity. The attribute information of the commodity may includes at least one of information selected from the marketing channel of the commodity, the promotion information of the commodity and the consumer information of the commodity.

Entrance information for buying commodity is supplied by the electronic commerce system. For example, for a commodity A, the entrance information of a website B for buying the commodity A is provided by the electronic commerce system. Users may buy the commodity A through the entrance information of the website B supplied by the electronic commerce system. In the embodiment, the marketing channel of the commodity is the channel corresponding to the entrance information for buying commodity, and the entrance information is supplied by the electronic commerce system. The marketing channel of the commodity includes a cost price corresponding to the channel of the commodity. In the example above, the channel of the commodity is the website B, the marketing channel of the commodity A includes the cost price of the commodity A supplied by the website B.

The promotion information of the commodity includes the promotion time information and the price adjustment information of the commodity. For example, the commodity A of the electronic commerce system has a promotion by 30% off in the time period 12:00-16:00 on Nov. 11, 2012. The promotion information of the commodity A may includes information which a real price of the commodity A is adjusted to 0.7 time of an original price during the time period 12:00-16:00 on Nov. 11, 2012.

The consumer information of the commodity includes a consumer consumption grade of the consumer aimed by the commodity, and price adjusting information corresponds to different consumers of different consumer consumption grades. Herein, the consumer consumption grade includes but not limits to very important person (VIP) member, regular member, and non-member. If the consumer is a VIP member, the real price of the commodity A is adjusted to 0.85 times of the cost price of the commodity A. If the consumer is a regular member, the real price of the commodity A is adjusted to 0.95 times of the cost price of the commodity A. If the consumer is non-member, the real price is not adjusted.

Step S102, distributing a charging mark to the commodity according to the attribute information of the commodity.

In the embodiment of present disclosure, for each commodity of the electronic commerce system, one kind of attribute information is corresponding to a charging mark of the commodity. The charging mark is configured to uniquely identify one kind of attribute information of the commodity of the electronic commerce system. For example, two same commodities A are included in the electronic commerce system, the attribute information of one commodity A is “a” and the attribute information of the other commodity A is “a′”. In the embodiment, the charging mark of the commodity A which attribute information is “a” is Ta, and the charging mark Ta is configured to uniquely identify the commodity A which attribute information is “a”. The charging mark of the commodity A which attribute information is “a′” is Ta′, and the charging mark Ta′ is configured to uniquely identify the commodity A which attribute information is “a′”. In another example, two different commodities B and C are included in the electronic commerce system. The attribute information of the commodity B is “b”, and the attribute information of the commodity C is “c”. The charging mark of the commodity B is Tb, and the charging mark Tb is configured to uniquely identify the commodity B. The charging mark of the commodity C is Tc, and the charging mark Tc is configured to uniquely identify the commodity C.

Step S103, setting price information to the charging mark of the commodity according to a predetermined price processing rule.

Herein, price information is corresponding to a charging mark. In the step, the predetermined price processing rule may be set according to the actual demand of the electronic commerce system operator. A process of setting the predetermined price may take the attribution information of the goods into consideration. For example, if the attribute information of the goods is marketing channel of the goods, the predetermined price processing rule may be set that the price of the commodity is processed 1.1 times of the cost price of the commodity. An exemplary embodiment is described in detail as the follows. If the attribute information of the commodity A is the marketing channel of the commodity A, the channel of the commodity A is website B, the cost price of the commodity A supplied by the website B is 12.5 RMB, and the charging mark of the commodity A is Ta. In the step, according to the predetermined price processing rule, the charging mark of the commodity A is set as 13.75 RMB. Another example, if the attribute information of the commodity is the promotion information of the commodity, and the predetermined price processing rule may be set as processing the price of the commodity according to the promotion of the commodity. An exemplary embodiment is described in detail as the follows. If the attribute information of the commodity A is the promotion information of the commodity A, the promotion information of the commodity A may be include “during the time period 12:00-16:00 on Nov. 11, 2012, the real price of the commodity A is adjusted to 0.7 times of the cost price”. The attribute information of the commodity of this embodiment is the charging mark Ta′ of the promotion. In the step, during the time period 12:00-16:00 on Nov. 11, 2012 the charging mark Ta′ is adjusted to 0.7 times of the cost price according to the predetermined price processing rule. The predetermined price processing rule may also be set that the price is processed according to the promotion information of the commodity and the consumer information of the commodity, etc. Similar analysis may refer to the predetermined price processing rule, and it is not repeated here.

In the embodiment, a relationship of the attribute information of the commodity, the charging mark of the commodity and the price information of the commodity may refer to the following table, table one.

TABLE ONE
relationship table

| | Attribute | Recharging | Price |
|---|---|---|---|
| Commodity | information | mark | information |
| A | a | Tₐ | Xₐ |
| A | a′ | Tₐ′ | Xₐ′ |
| B | b | T_{b} | Y |
| C | c | T_{c} | Z |
| D | d | T_{d} | M |
| . . . | . . . | . . . | . . . |

It is understood that the content of the table one is only an example. When the commodity of the electronic commerce system needed to process is changed, or the attribute information of each commodity changes or the predetermined price processing rule is changed, each content of the table one is changed correspondingly.

In the embodiment of present disclosure, a charging mark is distributed to the commodity according to the attribute information of the commodity of the electronic commerce system. Price information corresponding to the charging mark is set according to the predetermined price processing rule. The information price of the commodity is pertinently customized according to the attribute information of the electronic commerce system. The commodity of the electronic commerce system is strong pertinence that the price may be adjusted flexibly and efficiently, and the intelligence of the electronic commerce system is improved.

Referring to FIG. 2, FIG. 2 is a flow chart of a method for processing price according to another embodiment of present disclosure. The method includes the following steps S201-S204.

Step S201, obtaining attribute information of the commodity in an electronic commerce system.

Step S202, distributing a charging mark to the commodity according to the attribute information of the commodity.

Step S203, setting price information to the charging mark of the commodity according to a predetermined price processing rule.

In the embodiment, the steps S201-S203 may refer to the steps S101-S103 of the embodiment showing in the FIG. 1, which is not repeated here.

Step S204, feeding back the price information of the commodity according to the attribute information of the commodity of an order sheet, when an order sheet request of the commodity is received in the electronic commerce system.

In the step, if the user is shopping on the electronic commerce system, an order sheet operation may be generated to the commodity which the user wants to buy. The order sheet request is generated according to the order sheet operation. The order sheet request includes the attribute information of the commodity. The price information of the commodity requested is presented to user by processing the order sheet operation to the commodity requested by the user. The price information of the commodity is the cost price of the commodity requested to buy by the user.

In the embodiment of present disclosure, a charging mark is distributed to the commodity according to the attribute information of the commodity of the electronic commerce system. Price information corresponding to the charging mark is set according to the predetermined price processing rule. The information price of the commodity is pertinently customized according to the attribute information of the electronic commerce system. And the order sheet process is realized based on the price information customized. The commodity of the electronic commerce system is strong pertinence that the price may be adjusted flexibly and efficiently, and the intelligence of the electronic commerce system is improved.

Referring to FIG. 3, FIG. 3 is a flow chart of a method for processing price according to yet another embodiment of present disclosure. The method includes the following steps S301-S306.

Step S301, obtaining attribute information of a commodity in an electronic commerce system.

Step S302, distributing a charging mark according to the attribute information of the commodity.

Step S303, setting price information corresponding to the charging mark of the commodity according to a predetermined price processing rule.

In the embodiment, the steps S301-S303 may refer to the steps S101-S103 of the embodiment showing in the FIG. 1, which is not repeat here

Step S304, extracting the attribute information of the commodity of an order sheet request, when the order sheet request of the commodity in the electronic commerce system is received.

In the step, if the user is shopping on the electronic commerce system, an order sheet operation may be generated to the commodity which the user wants to buy. The order sheet request is generated according to the order sheet operation. The order sheet request includes the attribute information of the commodity. The attribute information of the commodity requested may includes one or more combinations of marketing channel of the commodity requested, the promotion information of the commodity, the consumer information of the commodity. For example, if the user wants to buy the commodity B on the electronic commerce system, during the process the user buys the commodity B, an order sheet request of the commodity B is generated. The order sheet request includes the attribute information of the commodity B. The attribute information of the commodity B abstracted from the order sheet request includes the following information. If the channel of the commodity B is a website C, then the marketing channel of the commodity B is the cost price of the commodity B supplied by the website C. If the commodity B does not participate in a sale promotion, then the attribute information does not include the promotion information. And the consumer information of the commodity B is not set. Form the description above, the attribution information of the commodity B is the marketing channel of the commodity B.

Step S305, searching the charging mark of the commodity according to the attribute information of the commodity.

Attribute information of the commodity is corresponding to a charging mark of the commodity in the electronic commerce system. The charging mark is configured to uniquely mark the attribute information of the commodity in the electronic commerce system. In the step, after the attribute information of the commodity requested is obtained, the charging mark corresponding to the attribute information of the commodity request is uniquely defined. According to the example described above, the commodity B which attribute information is marketing channel is response to a charging mark Ta.

Step S306, defining the price information corresponding to the charging mark of the commodity.

In the electronic commerce system, the price information is corresponding to a charging mark. In the step, after the charging mark of the commodity requested is searched, the price information corresponding to the charging mark of the commodity requested is uniquely defined. According to the above example, the commodity B which attribute information is marketing channel is uniquely corresponding to the charging mark Tb. In the step, the price information corresponding to the charging mark Tb is defined.

Step S307, feeding back the price information in response to the order sheet request.

In the step, the price information defined in the step S306 is feedback to respond the order sheet request. The price information of the commodity requested is obtained by the user. The price information is the real price paid by the user when the user wants to buy the commodity.

In the embodiment of present disclosure, a charging mark is distributed to the commodity according to the attribute information of the commodity of the electronic commerce system. Price information corresponding to the charging mark is set according to the predetermined price processing rule. The information price of the commodity is pertinently customized according to the attribute information of the electronic commerce system. And the order sheet process is realized based on the price information customized. The commodity of the electronic commerce system is strong pertinence that the price may be adjusted flexibly and efficiently, and the intelligence of the electronic commerce system is improved.

Further description of the device for processing price of present disclosure will be illustrated clearly and completely, which combined with FIG. 4 to FIG. 6. The device described as follows may also be implemented to the method described above.

See FIG. 4, FIG. 4 is a schematic diagram of a device for processing price according to an embodiment of present disclosure. The device includes an information obtaining module 101, a charging mark distributing module 102 and a price processing module 103.

The information obtaining module 101 is configured for obtaining attribute information of the commodity of the electronic commerce system.

The information obtaining module 101 may obtain the attribute information of any commodity of the electronic commerce system. The attribute information of the commodity is the factors influencing the price of the commodity. The attribute information of the commodity may includes at least one of information selected from the marketing channel of the commodity, the promotion information of the commodity and the consumer information of the commodity.

The charging mark distributing module 102 is configured for distributing a charging mark to the commodity according to the attribute information of the commodity.

In the embodiment of present disclosure, for each commodity of the electronic commerce system, one kind of attribute information is corresponding to a charging mark of the commodity. The charging mark is configured to uniquely identify one kind of attribute information of the commodity of the electronic commerce system. For example, two same commodity A are included in the electronic commerce system, the attribute information of one commodity A is “a” and the attribute information of the other commodity A is “a′”. In the embodiment, the charging mark of the commodity A which attribute information is “a” is Ta, and the charging mark Ta is configured to uniquely identify the commodity A which attribute information is “a”. The charging mark of the commodity A which attribute information is “a′” is Ta′, and the charging mark Ta′ is configured to uniquely identify the commodity A which attribute information is “a′”. In another example, two different commodity B and C are included in the electronic commerce system. The attribute information of the commodity B is “b”, and the attribute information of the commodity C is “c”. The charging mark of the commodity B is Tb, and the charging mark Tb is configured to uniquely identify the commodity B. The charging mark of the commodity C is Tc, and the charging mark Tc is configured to uniquely identify the commodity C.

The price processing module 103 is configured for setting price information to the charging mark of the commodity according to a predetermined price processing rule.

A charging mark is corresponding to price information. In the step, the predetermined price processing rule may be set according an actual need of the electronic commerce system operator. The attribute information of the commodity is needed to taken into consider during the setting process. In the embodiment, a relationship of the attribute information of the commodity, the charging mark of the commodity and the price information of the commodity may refer to the above table, table one.

In the embodiment of present disclosure, a charging mark is distributed to the commodity according to the attribute information of the commodity of the electronic commerce system. Price information corresponding to the charging mark is set according to the predetermined price processing rule. The information price of the commodity is pertinently customized according to the attribute information of the electronic commerce system. And the order sheet process is realized based on the price information customized. The commodity of the electronic commerce system is strong pertinence that the price may be adjusted flexibly and efficiently, and the intelligence of the electronic commerce system is improved.

Referring to FIG. 5, FIG. 5 is a schematic diagram of a device for processing price according to another embodiment of present disclosure. The device includes an information obtaining module 101, a charging mark distributing module 102, a price processing module 103 and an order from processing module 104. Herein, the structure of the information obtaining module 101, the charging mark distributing module 102, and the price processing module 103 can be refer to the description in the embodiment of the FIG. 4.

The order sheet processing module 104 is configured for feeding back the price information of the commodity according to the attribute information of the commodity of an order sheet request, when the order sheet request of the commodity of the electronic commerce system is received.

If the user is shopping on the electronic commerce system, an order sheet operation may be generated to the commodity which the user wants to buy. The order sheet request is generated according to the order sheet operation. The order sheet request includes the attribute information of the commodity. The price information of the commodity requested is presented to user by the order sheet processing module 104 processing the order sheet operation to the commodity requested by the user. The price information of the commodity is the cost price of the commodity requested to buy by the user.

In the embodiment of present disclosure, a charging mark is distributed to the commodity according to the attribute information of the commodity of the electronic commerce system. Price information corresponding to the charging mark is set according to the predetermined price processing rule. The information price of the commodity is pertinently customized according to the attribute information of the electronic commerce system. And the order sheet process is realized based on the price information customized. The commodity of the electronic commerce system is strong pertinence that the price may be adjusted flexibly and efficiently, and the intelligence of the electronic commerce system is improved.

Referring to FIG. 6, FIG. 6 is a schematic diagram of an order sheet processing module according to an embodiment of present disclosure. The order sheet processing module 104 includes an information extracting module 1401, a searching module 1402, a certifying module 1403 and a price feedback module 1404.

The information extracting module 1401 is configured for extracting the attribute information of the commodity from of the order sheet request, when the order sheet request of the commodity in the electronic commerce system is received.

When the user is shopping on the electronic commerce system, an order sheet operation may be generated to the commodity which the user wants to buy. The order sheet request is generated according to the order sheet operation. The order sheet request includes the attribute information of the commodity. The attribute information of the commodity requested may includes one or more combinations of marketing channel of the commodity requested, the promotion information of the commodity requested, the consumer information of the commodity requested. For example, if the user wants to buy the commodity B on the electronic commerce system, during the process the user buys the commodity B, an order sheet request of the commodity B is generated. The order sheet request includes the attribute information of the commodity B. The attribute information of the commodity B abstracted by the information extracting module 1401 form the order sheet request includes the following information. If the channel of the commodity B is a website C, then the marketing channel of the commodity B is the cost price of the commodity B supplied by the website C. If the commodity B does not participate in a sale promotion, then the attribute information does not include the promotion information. And the consumer information of the commodity B is not set. Form the description above, the attribution information of the commodity B is the marketing channel of the commodity B.

The searching module 1402 is configured for searching the charging mark of the commodity according to the attribute information of the commodity.

Attribute information of the commodity is corresponding to a charging mark of the commodity in the electronic commerce system. The charging mark is configured to uniquely mark the attribute information of the commodity in the electronic commerce system. In the step, after the attribute information of the commodity requested is obtained, the charging mark corresponding to the attribute information of the commodity request is uniquely defined. According to the example described above, the commodity B which attribute information is marketing channel is in response to a charging mark Ta.

The certifying module 1403 is configured for defining the price information corresponding to the charging mark according to the found charging mark of the commodity requested.

In the electronic commerce system, the price information is corresponding to a charging mark. In the step, after the charging mark of the commodity requested is searched, the price information corresponding to the charging mark of the commodity requested is uniquely defined. According to the above embodiments, the commodity B is uniquely corresponding to the charging mark Tb. Herein the attribute information of the commodity B is marketing channel. The price information corresponding to the charging mark Tb is defined by the certifying module 1403.

The price feedback module 1404 is configured for feeding back the price information in response to the order sheet request.

The price information defined by the certifying module 1403 is feed back by the price feedback module 1404. The price information of the commodity requested is obtained by the user. The price information is the real price paid by the user when the user wants to buy the commodity.

In the embodiment of present disclosure, a charging mark is distributed to the commodity according to the attribute information of the commodity of the electronic commerce system. Price information corresponding to the charging mark is set according to the predetermined price processing rule. The information price of the commodity is pertinently customized according to the attribute information of the electronic commerce system. And the order sheet process is realized based on the price information customized. The commodity of the electronic commerce system is strong pertinence that the price may be adjusted flexibly and efficiently, and the intelligence of the electronic commerce system is improved.

Referring to FIG. 7, FIG. 7 is a schematic diagram of an electronic commerce system according to an embodiment of present disclosure. The electronic commerce system includes at least one commodity and a price processing device. The structure of the price processing device may refer to the description illustrated in the embodiments of the FIG. 4 to FIG. 6, which is not repeated here. It is noted that the electronic commerce system of the embodiment may be implanted on the method described above.

In the embodiment of present disclosure, a charging mark is distributed to the commodity according to the attribute information of the commodity of the electronic commerce system. Price information corresponding to the charging mark is set according to the predetermined price processing rule. The information price of the commodity is pertinently customized according to the attribute information of the electronic commerce system. And the order sheet process is realized based on the price information customized. The commodity of the electronic commerce system is strong pertinence that the price may be adjusted flexibly and efficiently, and the intelligence of the electronic commerce system is improved.

Referring to FIG. 8, FIG. 8 is flow chart of a method for processing an order sheet according to an embodiment of present disclosure. The method includes following steps: a step S401 to a step S409.

Step S401, obtaining attribute information of a commodity in an electronic commerce system.

Herein, the attribute information of the commodity is the factors influencing the price of the commodity. The attribute information of the commodity may include at least one of the marketing channels of the commodity, the promotion information of the commodity and the consumer information of the commodity.

Step S402, distributing a charging mark to the commodity according to the attribute information of the commodity by the server.

In the embodiment of present disclosure, for each commodity of the electronic commerce system, one kind of attribute information is corresponding to a charging mark of the commodity. The charging mark is configured to uniquely identify one kind of attribute information of the commodity of the electronic commerce system.

Step S403, setting price information corresponding to the charging mark of the commodity according to a predetermined price processing rule. Herein a charging mark is corresponding to price information.

The step S401 to the step S403 described above is a price process of the server. The price process may form a relationship table as shown in the table one. The relationship reflects a relationship of the attribute information of the commodity, a charging mark of the commodity, price information of the commodity. A price database is established by the server through the step S401 to the step S403. The price database is configured for storing the relationship of the attribute information of the commodity, a charging mark of the commodity, price information of the commodity.

Step S404, obtaining the attribute information of the commodity when an order sheet operation to the commodity in the electronic commerce system is detected by a client.

In the step, when the user is shopping on the electronic commerce system, an order operation may be generated to the commodity which the user wants to buy. The attribute information is obtained by the client according to the order sheet operation and an order sheet request is generated. The order sheet request includes the attribute information of the commodity.

Step S405, transmitting an order sheet request with the attribute information of the commodity to the server by the client. Herein the commodity requested in the order sheet is the commodity in the order sheet request operated by the user.

Step S406, searching a charging mark to the commodity in a price database according to the attribute information of the commodity requested by the server.

As described above, the price database is established by the server. The relationship (such as the relationship table in the table one) of the attribute information of the commodity, a charging mark of the commodity, price information of the commodity is stored in the price database. The charging mark is configured to uniquely mark attribute information of the commodity in the electronic commerce system. In the step, the charging mark of the commodity requested is searched in the price database according to the attribute information request by the server.

Step S4017, defining price information corresponding to the charging mark according to the charging mark of the commodity searched by the server.

In the electronic commerce system, a charging mark is corresponding to price information. In the step, after the charging mark of the commodity is searched by the server, the price information is uniquely defined according to the charging mark of the commodity request.

Step S408, feeding back the price information to the client by the server.

Step S409, displaying the price information by the client on an order sheet of the commodity.

The user obtains the price information of the commodity request according to the order sheet displayed by the client. The price information is an actual price paid by the user when the user buys the commodity.

In the embodiment of present disclosure, a charging mark is distributed to the commodity according to the attribute information of the commodity of the electronic commerce system. Price information corresponding to the charging mark is set according to the predetermined price processing rule. The information price of the commodity is pertinently customized according to the attribute information of the electronic commerce system. An order sheet process based on the customize price information is realized. The commodity of the electronic commerce system is strong pertinence that the price may be adjusted flexibly and efficiently, and the intelligence of the electronic commerce system is improved.

Referring to FIG. 9, FIG. 9 is a schematic diagram of an electronic commerce system according to another embodiment of present disclosure. The electronic commerce system includes at least one commodity, a sever, and a client.

The server is configures for receiving an order request transmitted by the client, searching for the charging mark of the commodity in the price database according to the attribute information of the commodity carried in the order request, defining the price information corresponding to the charging mark according to the charging mark of the commodity requested, feeding back the price information to the client. Herein, the price database may be established through the following steps: acquiring the attribute information of the commodity in the electronic commerce system, distributing the charging mark to the commodity according to the attribute information of the commodity, setting price information corresponding to the charging mark of the commodity according to a predetermined price processing rule.

The client is configured for obtaining the attribute information of the commodity when an order sheet operation to the commodity in the electronic commerce system is detected, transmitting an order sheet request to the server. The attribute information is carried in the order sheet requested. The client is also configured for receiving the price information of the commodity feed back by the server, and displaying the price information in the order sheet of the commodity.

In the embodiment of present disclosure, the charging mark is distributed to the commodity according to the attribute information of the commodity of the electronic commerce system. Price information corresponding to the charging mark is set according to the predetermined price processing rule. The information price of the commodity is pertinently customized according to the attribute information of the electronic commerce system. And the order sheet process is realized based on the price information customized. The commodity of the electronic commerce system is strong pertinence that the price may be adjusted flexibly and efficiently, and the intelligence of the electronic commerce system is improved.

To a person of ordinary skill in the art, part of or all of the flow chart in the method of the above embodiments may be implemented by a hardware which is related to computer programs. The program may be stored in a computer readable storage medium. When the programs are implemented, the flow chart of the methods described above is executed. Herein, the storage media may be disk, computer disk (CD), read-only memory (ROM) or random access memory (RAM) etc.

While the present invention has been described with reference to particular embodiments, it will be understood that the embodiments are illustrative and that the invention scope is not so limited. Such alternate embodiments are considered to be encompassed within the spirit and scope of the present invention.

1. A method for processing price, comprising:
obtaining attribute information of a commodity in an electronic commerce system;
distributing a charging mark to the commodity according to the attribute information of the commodity; and
setting price information to the charging mark of the commodity according to a predetermined price processing rule.

2. The method according to claim 1, wherein the attribute information of the commodity comprises at least one of a marketing channel of the commodity, promotion information of the commodity, and consumer information of the commodity.

3. The method according to claim 1, wherein after the step of setting price information to the charging mark of the commodity according to a predetermined price processing rule, the method further comprises:
feeding back the price information of the commodity according to the attribute information of the commodity of an order sheet, when an order sheet request of the commodity is received in the electronic commerce system.

4. The method according to claim 3, wherein the step of feeding back the price information of the commodity according to the attribute information of the commodity of the order sheet, when an order sheet request of the commodity of the electronic commerce system is received in the electronic commerce system, comprises:
extracting the attribute information of the commodity from the order sheet request, when the order sheet request of the commodity in the electronic commerce system is received;
searching the charging mark of the commodity according to the attribute information of the commodity;
defining the price information corresponding to the charging mark according to the charging mark of the commodity;
feeding back the price information in response to the order sheet request.

5. A device for processing price, comprising:
an information obtaining module configured to obtain attribute information of a commodity in an electronic commerce system;
a charging mark distributing module configured to distribute a charging mark to the commodity according to the attribute information of the commodity; and
a price processing module configured to set price information to the charging mark of the commodity according to a predetermined price processing rule.

6. The device according to claim 5, wherein the attribute information of the commodity comprises at least one of a marketing channel of the commodity, promotion information of the commodity, and consumer information of the commodity.

7. The device according to claim 5, further comprising:
an order sheet processing module configured to feedback the price information of the commodity according to the attribute information of the commodity of an order sheet request, when an order sheet request of the commodity is received in the electronic commerce system.

8. The device according to claim 7, wherein the order sheet processing module comprises:
an information extracting module configured to extracting the attribute information of the commodity from the order sheet request, when the order sheet request of the commodity in the electronic commerce system is received;
a searching module configured to search a charging mark of the commodity according to the attribute information of the commodity;
a certifying module configured to define the price information corresponding to the charging mark according to the charging mark of the commodity; and
a price feedback module configured to feedback the price information in respond to the order sheet request.

9. (canceled)

10. A method for processing an order sheet, comprising:
obtaining an attribute information of a commodity when an order sheet operation to the commodity in an electronic commerce system is detected by a client;
transmitting an order sheet request with the attribute information of the commodity to the server by the client;
searching a charging mark to the commodity in a price database according to the attribute information of the commodity requested by the server;
defining price information corresponding to the charging mark according to the charging mark of the commodity searched by the server and feeding back the price information to the client by the server; and
displaying the price information on an order sheet of the commodity by the client;
an establishment of establishing the price database by the server comprising:
obtaining the attribute information of the commodity in the electronic commerce system;
distributing the charging mark according to the attribute information of the commodity; and
setting the price information to the charging mark of the commodity according to a predetermined price processing rule.

11. An electronic commerce system comprises a sever and a client,
the server receiving an order sheet request transmitted by the client, searching for a charging mark of a commodity in a price database according to attribute information of the commodity carried in the order sheet request, defining price information corresponding to the charging mark according to the charging mark of the commodity, feeding back the price information to the client;
the client obtaining attribute information of the commodity when an order sheet operation to the commodity in the electronic commerce system is detected, transmitting the order sheet request to the server; the order sheet request carrying with the attribute information; receiving the price information of the commodity feed back by the server, and displaying the price information on an order sheet of the commodity;
an establishment of establishing the price database by the server comprising:
obtaining the attribute information of the commodity in the electronic commerce system;
distributing the charging mark according to the attribute information of the commodity; and
setting the price information to the charging mark of the commodity according to a predetermined price processing rule.

12. The method according to claim 2, wherein after the step of setting price information to the charging mark of the commodity according to a predetermined price processing rule, the method further comprises:
feeding back the price information of the commodity according to the attribute information of the commodity of an order sheet, when an order sheet request of the commodity is received in the electronic commerce system.

13. The device according to claim 6, further comprising:
an order sheet processing module configured to feedback the price information of the commodity according to the attribute information of the commodity of an order sheet request, when an order sheet request of the commodity is received in the electronic commerce system.
